(19) United States
(12) Patent Application Publication
(10) Pub. No.: US 2023/0345067 A1
(43) Pub. Date: Oct. 26, 2023

(54) PROGRAMMATIC MEDIA CONTENT EXCHANGE BETWEEN CONTENT OWNERS AND OTT CONTENT DISTRIBUTORS

(71) Applicant: M/S. Amagi Media Labs Pvt. Ltd., Bangalore (IN)

(72) Inventor: Baskar Subramanian, Bangalore (IN)

(73) Assignee: M/S. Amagi Media Labs Pvt. Ltd., Bangalore (IN)

(21) Appl. No.: 18/305,340

(22) Filed: Apr. 22, 2023

(30) Foreign Application Priority Data
Apr. 22, 2022 (IN) 202241023814

(51) Int. Cl. H04N 21/262; H04N 21/81; H04N 21/2668; H04N 21/235; H04N 21/845; H04N 21/234; H04N 21/2543

(52) U.S. Cl. CPC H04N 21/26258; H04N 21/23424; H04N 21/2353; H04N 21/2543; H04N 21/2668; H04N 21/812; H04N 21/8455

(57) ABSTRACT

A system and method and for programmatic distribution between content owners and distributors that serve users, having (a) a content provider platform, (b) a media asset manager, (c) a programmatic distribution system (d) a distributor backend, (e) a distributor platform, and (f) a distributor app, in which the content provider platform is a conduit for content owners to make content they own, available for distribution. The media asset manager is a repository of assets, including metadata, that are being exchanged and used for content discovery and ranking. The programmatic distribution system further includes a content exchange and a dynamic content block replacement engine. The distributor backend is a set of Application Programming Interfaces hosted by the distributor, that talk to distributor apps. The distributor platform is a platform hosted for the distributor that provides the distributor the capability to perform administrative tasks. Distributor applications talk to the distributor backend.

### CROSS REFERENCE TO RELATED APPLICATIONS

This patent application claims priority on and the benefit of India Patent Application No. 202241023814 having a filing date of 22 Apr. 2022 entitled “Programmatic Media Content Exchange Between Content Owners and OTT Content Distributors”.

### FIELD OF THE INVENTION

This invention describes a system and method for programmatic distribution for media content exchange between content owners and OTT content distributors.

### BACKGROUND AND PRIOR ART

There has been an exponential increase in consumers accessing their media content through multitude of OTT distribution platforms, worldwide. An unprecedented explosion of content creation has matched this trend across the globe.

Consumers are demanding ever new and a broad variety of content daily. OTT distributors are commissioning new content at a record pace. Even with this pace, it is impossible for any OTT distributor to cater to all of their viewer needs, without buying content from third parties.

This has led to a content buyout spree among OTT distributors from all possible global content owners and aggregators. The current system to buy is based on i) direct one-on-one interactions, ii) through human agents or iii) through online discovery and rent/own transaction platform.

The key problem with all the above approaches of buying content is the need for content distributors to decide on specific content that their viewers would demand in the future, in the budget constraint of what they are willing to spend. This is currently being addressed by exploring past viewer behavior to predict the future content needs from these viewers.

### BRIEF SUMMARY OF THE INVENTION

A system and for programmatic distribution between content owners 1, 2, 3 and one or more distributors 30, 31, 32 that serve one or more users User1-3, comprising (a) a content provider platform 400, (b) a media asset manager 100, (c) a programmatic distribution system 200, (d) a distributor backend 500, (e) a distributor platform 600, and (f) a distributor app 20 wherein the content provider platform 400 is a conduit for one or more content owners 1, 2, 3 to make content they own, available for distribution. The media asset manager 100 is a repository of assets, including their metadata, that are being exchanged and used for content discovery and ranking. The programmatic distribution system 200 further comprises a content exchange 200-a and a dynamic content block replacement engine 200-b. The distributor backend 500 is a set of Application Programming Interfaces (APIs) hosted by the distributor, that talk to one or more distributor apps. The distributor platform 600 is a platform hosted for the distributor that provides the distributor the capability to perform administrative tasks. One or more distributor applications 20 which talks to the distributor backend 500. A method for programmatic distribution between content owners 1, 2, 3 and one or more distributors 30, 31, 32 that serve one or more users User1-3, comprising the steps of (a) Populating the media asset manager with content and metadata; (b) Performing programmatic distribution; and (c) Delivering content back to the users for consumption. A system and method of the above described invention which is capable of channel generation.

### BRIEF DESCRIPTION OF THE DRAWINGS

FIG. 1 illustrates the overall representation of the programmatic distribution system.

FIG. 2 illustrates the Media Asset Manager.

FIG. 3 illustrates a high level representation of programmatic content exchange between content owners and distributors.

FIG. 3a illustrates content distribution through exchange and bidding.

FIG. 4 illustrates dynamic content replacement Engine.

FIG. 4a describes content blocks.

FIG. 4b describes the functionality of Dynamic content block replacement.

FIG. 5 illustrates Channel generation service Abstract.

FIG. 5a illustrates Dynamic Channel creation.

FIG. 5b illustrates Channel Generation Service.

FIG. 6 illustrates Flow of insertion content and metadata into the Media Asset Manager.

FIG. 7 illustrates Content Exchange Flow Chart.

FIG. 8a illustrates Flowchart describing channel generation by the dynamic content block replacement engine.

FIG. 8b illustrates Flowchart describing consumption of channels generated by the dynamic content block replacement engine.

FIG. 9 illustrates Channel generation service flowchart.

### DETAILED DESCRIPTION OF THE PREFERRED EMBODIMENTS

A programmatic distribution system has few major characteristics that define it including speed, personalization, and adaptability (i.e., whether it is programmatic and real time). Content Exchange helps bridge the gap between content and reach through automated programmatic distribution of content. The programmatic distribution aligns itself with multiple models of distribution including (a) Content distribution through exchange and bidding, using a content exchange, (b) pop-up/real-time/bouquet channel-creation, and (c) insertion of personalized content into existing channels. These systems are described in the figures in this document.

We provide a brief explanation of terms below -

Content Owner (CO) -- Content Provider is a studio, company or a creator who have original content or have license to video content for sale.

Distributor -- Distributor is an OTT platform, TV channel, an app, or anyone who wants to acquire a license of video content to use for consumption of its end users.

Content Provider Platform -- Content Provider Platform is the interface for Content Providers to interact with the exchange. A content provider may choose to provide multiple information about the content such as viewership history, rights details, type and genre of the content made available, and minimum expected price for the title so that the exchange as well as distributors can make purchase decisions.

Distributor Side Platform -- Distributor Side Platform is the interface for Distributors to interact with the exchange. A distributor may choose to provide multiple information about the type of content looking for which may be upfront or in real-time when a viewer is looking for some content. This may be the type of audience, genre of content, title, acquisition price, etc.

Content Exchange -- Exchange facilitates the programmatic handshake to make content acquisition in real-time. Deals in exchange happen based on the parameters from both Content Provider Platform and Distributor Side Platform as explained above.

Channel Generation Service - Channel generation service helps generate channels on the fly using the context from the customer (on the distributor app).

Dynamic Content Block Insertion Engine - The dynamic content block insertion engine inserts content into a dynamic block planned by a media planner.

Content Stitching -- Based on the deals happening in the exchange, required content will be acquired from the content server, which may be outside this ecosystem to stitch together in the linear stream for the viewer to watch. In case of Video On Demand (VOD) content, the required titles would be fetched from the content servers and made available to the distributor.

Ad Stitching -- A server side ad insertion service may be used along with the content to help distributors monetize the content being made available to the viewers. Once the required content is pulled based on deals happening in the exchange, ad-stitching happens before playout of content to the viewer.

Playout system -- A cloud playout system may be involved for the required content to create a linear viewing experience for the consumers.

There are two platforms that form the backbone of the entire system. They are:
1. The content provider platform; and
2. The distributor platform.

They are described in detail below:

### Content Provider Platform

The content provider platform is sitting on the top of cloud computers in locations close to the content provider. For instance, if a content provider is in West US, a west US cloud instance would be used to host the content provider platform. This is done with the help of hardware of software reverse proxies that are sitting in front of these requests. This helps in reducing the time it takes for a content provider to interact with the platform.

The Content Provider Platform has the following components - the creator platform is the UI component that shall be available for content owners and creators to perform the following tasks.

### 1. Ingest and Curate Content

The content providers would want to ingest content to make it available for bidding and sale. Along with the content, the content owners would also ingest content metadata such as content creation date, content description, etc.; content rights information such as audience, geographical restrictions on the content, etc.; content bidding information such as the floor price for content, secondary bid price, etc. Content ingestion can either happen through a user interface or through content APIs that would allow third party agencies hired by the content owners to upload content and its metadata. This will also allow content owners to create content bouquets for curation and sale with the distributors.

### 2. Reporting Dashboards

It is important that the content owners understand how their content is used and played out. These dashboards will give content owners a view of drop out rates, buffering rates, video pause and play information, ads utilisation, monetization information per content, etc.

### 3. Billing Information

This will help the content owners understand the monetization aspects of their content. How much money has each content made through ads, what demographic has provided the highest CPMs, etc.

### 4. Content API Gateway

This API gateway will be used by the UI platform and agencies to ingest content directly into Amagi Media asset manager for further processing and distribution. API gateway will have rate limiting and content validation features to prevent abuse.

### 5. Bidding System

This service receives content bids from the exchange and takes a decision on whether to act on it. The exchange would send a bid for the content and the bidding service would decide on the basis of floor price and highest available bid on the content. Frameworks such as openRTB can be used to calibrate the bidding system.

The distributor platform:
The distributor interacts with the distributor platform which comprises of the following user experiences.
Biller - Allows the distributor to look at the invoices for purchasing content through the content exchange.
Budget Manager - Allows the distributor to manage budgets used for purchasing content inventory. Helps them plan what content to buy and which to skip.
Subscription Management - Helps distributors manage the content providers they are subscribed to. They can also look at the content bouquests or channels they have ordered.
Channel store - For distributors to browse over the existing available channels for bidding.

### 1 Content Distribution Through Exchange and Bidding

A few examples are outlined below to elaborate our system architecture’s components and how it applies to specific scenarios. This are only representative samples and not an exhaustive list.

### Example 1 -

1. Content Studios such as Warner Bros., Content Aggregators such as Tastemade and small-content creators such as a Youtuber would list their content and selling proposals in the exchange through Content Provider Platform.

2. A Distributor such as Samsung TV Plus, The Roku Channel, or Tastemade access the exchange through Distributor Side Platform by providing their buying preferences.

3. Based on the real-time requirements between both the sides, Exchange facilitates bidding for content acquisition.

4. Once a deal is finalized in the exchange, required content is pulled from content servers and stitched together in a stream.

5. To monetize the content, a server side ad-insertion service pulls the required ads and stitch together with the content.

6. Playout system takes care out playing out the linear content along with ads to the end consumer.

### Example 2:

1. A viewer goes to Disney+ (Distributor) and searches for a particular movie which is not available at present with the distributor.

2. Disney+ access Exchange through Distributor Side Platform and provides information such as viewer’s geography, acquisition price that Disney+ is ready to pay, licensing requirements, etc.

3. The requested movie may be made available in the exchange by multiple Content Providers. One Content Provider may have rights for all geographies and is ready to sell the content for a particular price point. Another Content Provider may have rights to certain geographies and is willing to sell the content at a lower price point.

4. If the bidding requirements from Distributor side such as price point, rights requirements meet, deal between the selected Content Provider, and Distributor happens in the Exchange.

5. The required title is pulled from the content servers and delivered to the Distributor.

In this model one or more distributors and content providers liaise through an exchange. The content provider, or anyone with rights to sell content, through the content platform, makes content available for consumption. Along with the content, the content provider also provides metadata encapsulating information such as Genre of the content, Rights available on the content, Floor price of content for bidding purposes, target audience of the content, administrative fields about the content such as created date, release date, etc. All of the content metadata will be stored with the media asset manager as as described earlier in the document, and will be used for content discovery and ranking. The distributor side platform shall create the purchase information, manage budgeting, and also create real time requests for content with a certain query pattern. The query will be matched by the content exchange, which will now return all the content available by eliminating duplicates. Once the user on the distributor platform clicks on a content of choice the exchange will create a bid on behalf of the distributor. The bidding shall be done by multiple content platforms and the winning bid shall be sent back to the distributor platform for delivery. In some situations, based on the distributor’s request parameters, the exchange will solicit an advertiser to place ads on the content and subsidize proportion of the final charges to the viewer. The content will be stitched with the ads, be DRM protected, be backed by a content licence and delivered via an HLS/DASH stream.

### 2. Pop-Up/Real Time/Bouquet Channel Creation

For this user case, we will generate a pop-up channel or an on-demand channel for a linear programmer. A linear programmer is a content distributor who runs linear channels that allow customers to watch programs one after the other without choosing content. This is similar to a broadcast or a DTH experience. This is also referred to as a lean-back way of content consumption. There are a variety of distributors who would want to create channels on the fly along with the programming guide. Channel generation service will bundle similar content based on relevance markers for these distributors to create pop up channels for them. These channels can be temporary in that they can be brought up programmatically and closed with time.

### 3. Insertion of Personalized Content Into Existing Channels

Channels on distributor platforms can leave slots of content open for programmatic insertion. These slots may be open due to a variety of reasons. Some of them could be repetitive content, lack of personalization, low CPMs (Cost per thousand impressions) on ads, etc. This content can be inserted in real time programmatically using incoming consumer behavioral data. Content can also be replaced by branded content, or the content itself can be supplemented with dynamic brand insertions. This would allow brands to be inserted in between content playout in the form of banners or picture in picture.

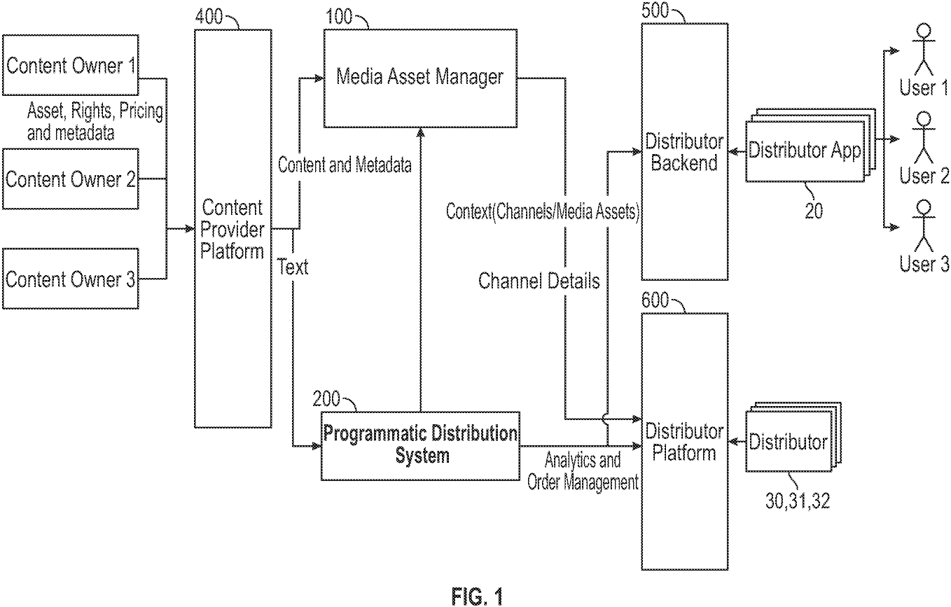

FIG. 1 illustrates the overall system wherein one or more distributors 30, 31, 32 and content providers 1, 2, 3 liaise through an exchange. The content owner 1, 2, 3, or anyone with rights to sell content, through the content provider platform 400, makes content available for consumption. The content gets stored in a Media asset manager 100. Along with the content, the content provider also provides metadata encapsulating information such as Genre of the content, rights available on the content, Floor price of content for bidding purposes, target audience of the content, administrative fields about the content such as created date, release date, etc. All of the content metadata will be stored with the Media asset manager 100 as would be described later in the document, and will be used for content discovery and ranking. The distributor will have one or more distributor applications (apps) 20 which will talk to the distributor backend 500, which is a set of APIs hosted by the distributor, that talk to the distributor apps (such as a mobile app or a web application. The distributor app shows the distributor content and uses the backend to communicate with the distributors or an external library of content. The distributor side platform 600 is a platform hosted for the distributor that provides the distributor the capability to order channels, look at analytics of existing channels, approve channel delivery, look at billing information, etc., and it creates the purchase information, manages budgeting, and also capture analytics and order information from the content exchange. The distributor backend, on behalf of the distributor app, will send a content query to programmatic distribution system 200, further comprised of a content exchange 200-a and a dynamic content block replacement engine 200-b, which utilize user context in their functioning and a channel generation service 201 which talks to distributors only. The query will be matched by the content exchange, which will now return all the content available by eliminating duplicates. Once the user on the distributor app clicks on a content of choice the exchange will be called again by the distributor app through the distributor backend. This time the exchange will help procure content and send it back to the distributor backend. The stream is passed through the delivery and distribution manager 300 which understands the distributor platform well, and takes a decision based on platform spec that is stored in the delivery and distribution manager 300 on whether the delivery should happen via a CDN, through an API etc. The details of the delivery and distribution manager and ad stitching are out of scope of this invention.

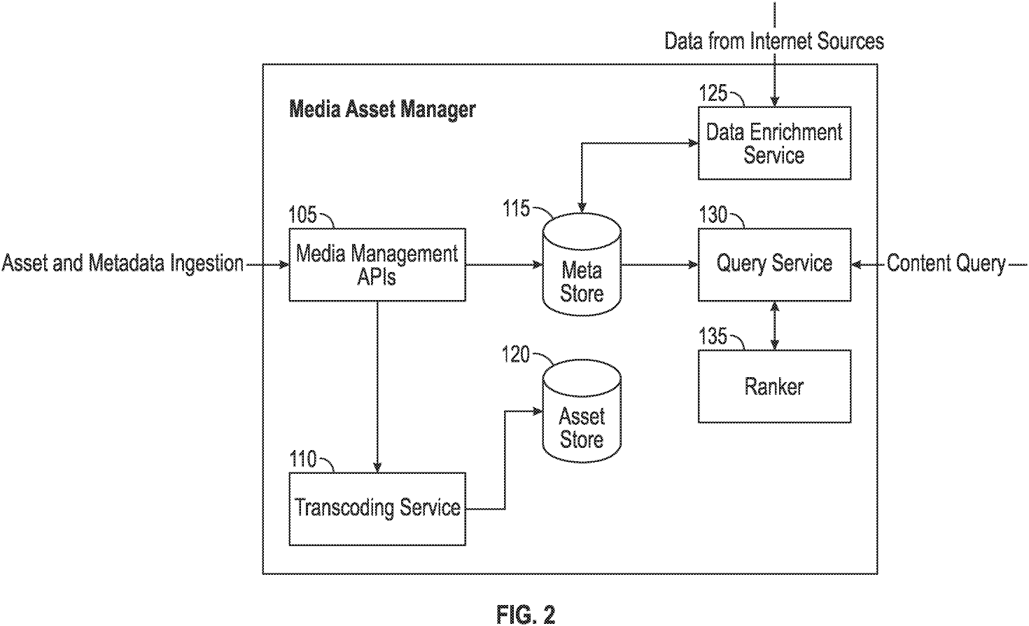

FIG. 2 describes the Media asset Manager. The Media asset manager updates and manages the assets and their metadata uploaded on the content provider platform 400. The asset and metadata ingestion requests come to the media management APIs 105. The Media can be uploaded in various formats such as MRSS, CSV, or can be uploaded from a remote storage location. The metadata is stored in the Metastore 115 and the assets are stored in the Asset store 120 after passing through the transcoding service 110 which transcodes the assets into standard packaging formats supported by the system. Whenever Media asset manager is queried, the queries are passed to a query service 130, which uses a Ranker 135 to help it score the query results and sort them according to the score and return the sorted results.

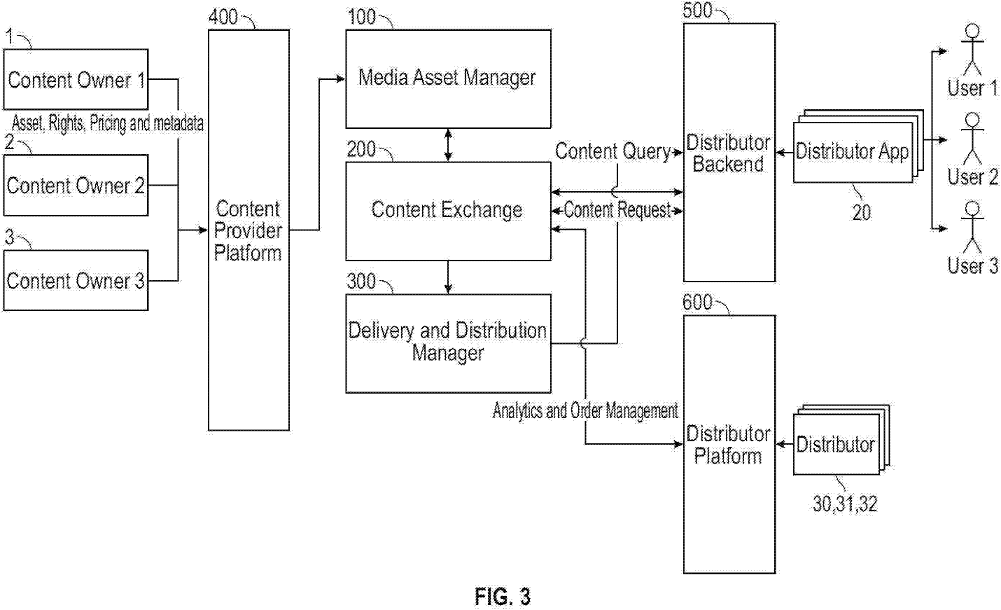

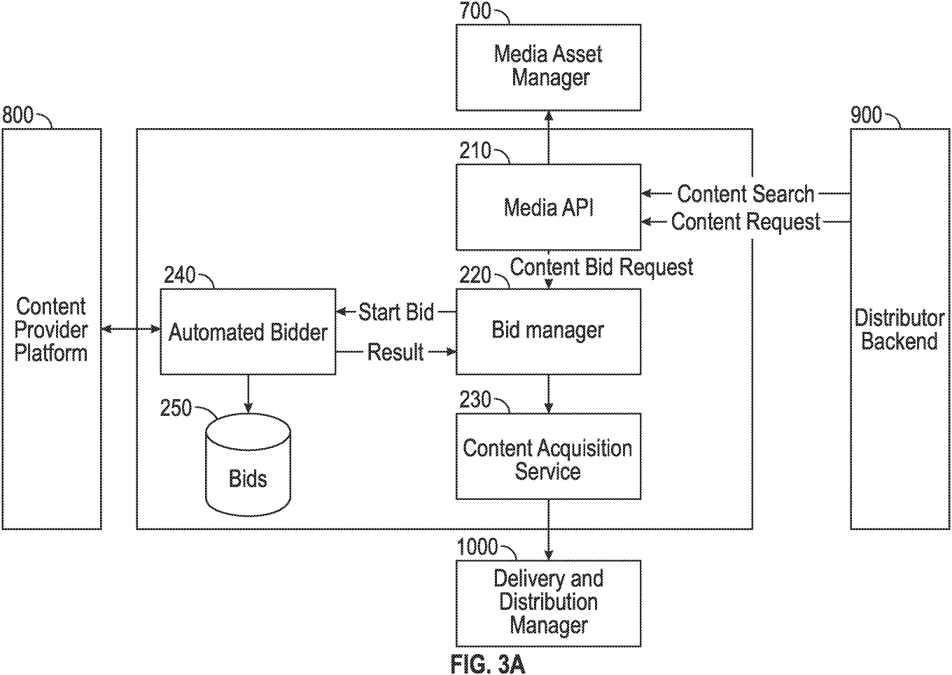

FIG. 3 illustrates a high level representation of programmatic content exchange between content owners and distributors. One or more distributors and content providers liaise through an exchange. The content owner 1, 2, 3, or anyone with rights to sell content, through the content provider platform 400, makes content available for consumption. The content gets stored in a Media asset manager 100. Along with the content, the content provider also provides metadata encapsulating information such as Genre of the content, rights available on the content, Floor price of content for bidding purposes, target audience of the content, administrative fields about the content such as created date, release date, etc. All of the content metadata will be stored with the Media asset manager 100 as would be described later in the document, and will be used for content discovery and ranking. The distributor will have one or more distributor applications (apps) 20 which will talk to the distributor backend 500. The distributor app shows the distributor content and uses the backend to communicate with the distributors or an external library of content. The distributor side platform 600 shall create the purchase information, manage budgeting, and also capture analytics and order information from the content exchange. The distributor backend, on behalf of the distributor app, will send a content query to content exchange 200. The query will be matched by the content exchange, which will now return all the content available by eliminating duplicates. Once the user on the distributor app clicks on a content of choice the exchange will be called again by the distributor app through the distributor backend. This time the exchange will help procure content and send it back to the distributor backend. The stream is passed through the delivery and distribution manager 300 which understands the distributor platform well, and takes a decision based on platform spec that is stored in the delivery and distribution manager 300 on whether the delivery should happen via a CDN, through an API etc. The details of the delivery and distribution manager and ad stitching are out of scope of this invention.

FIG. 3a shows content distribution through exchange and bidding. As explained earlier the Distributor backend sends content query to the content exchange 200. Within the content exchange the request goes to the Media API 210, which is the API gateway to the content exchange and handles all incoming API calls to the exchange. For instance, show me all the Sylverter Stallone movies in the Rambo series. This request along with the user context is sent to the Media API, which reaches out to the Media Asset Manager 700.The Media API, on receiving the content query, passes the request to Media Asset Manager 700, which responds with the results of the content query in the form of a list of contents. This content list can contain duplicates as well since two content providers might upload the same content. The Media API, de-duplicates the query results it gets from Media asset manager and sends it back to the distributor backend 900. The distributor app 20 shows the results from the distributor backend 900 to the user, who then clicks on one of the results. If the result is from the content exchange 200, the distributor app through the distributor backend calls the content exchange Media API 210 again to acquire the content. The Media API passes on the content bid request to the Bid Manager 220. The bid manager creates a bid request and starts a bid and sends it to the automated bidder 240. The automated bidder talks to the content provider platform to get the floor prices and other bid details from the content provider platform 800. The bidding shall be done by multiple content owners and the winning bid shall be sent back to the Bid Manager 220 for delivery. The bids are also stored internally in a Bids store 250 so that they can be provided to content owners and distributors for auditing and tracking purposes. Once the winning bid is selected the content is fetched from the Media asset manager and passed onto the content acquisition service 230. In some situations, based on the distributor’s request parameters, the content acquisition service will solicit an advertiser to place ads on the content and subsidise a proportion of the final charges to the viewer. The content will be stitched with the ads, be DRM protected, be backed by a content licence and delivered through the delivery and distribution manager 1000.

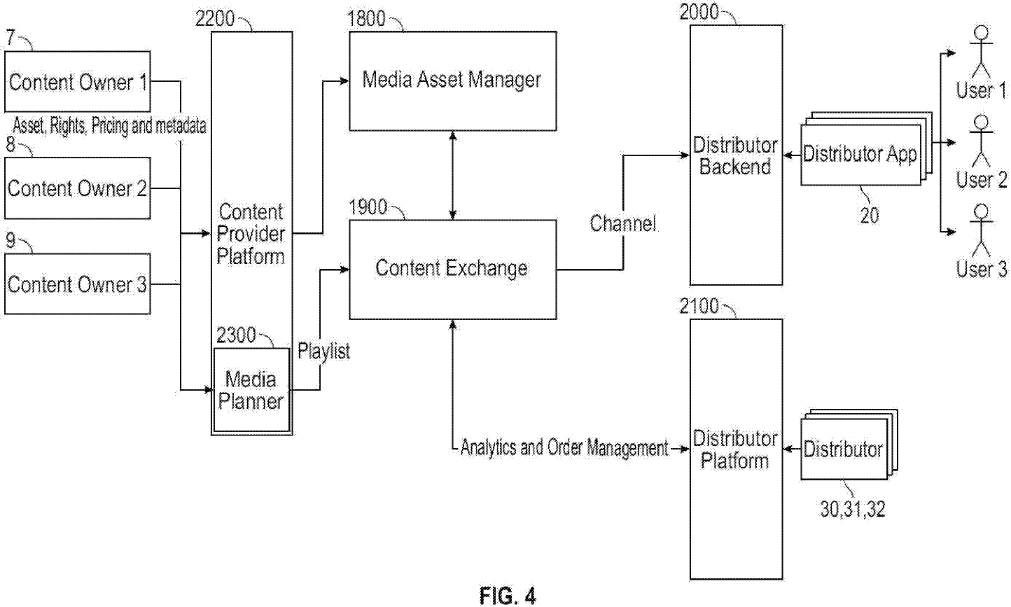

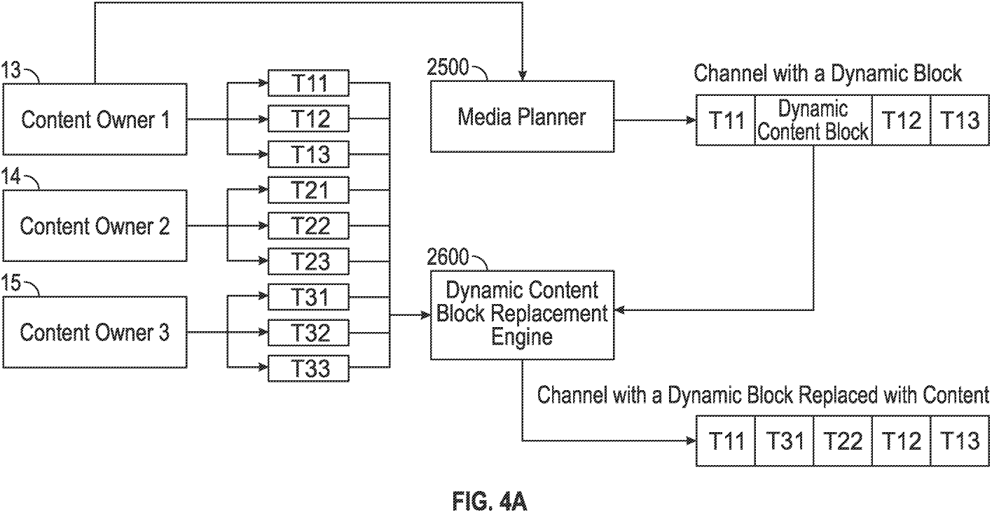

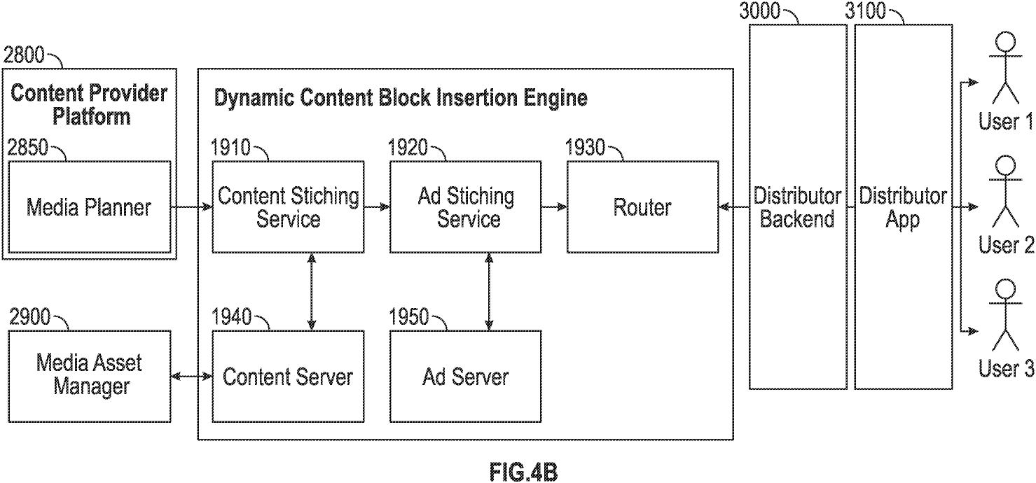

FIG. 4 illustrates the dynamic content replacement engine. Multiple content owners 1, 2, 3, publish their content to the content provider platform 2200 through its interfaces. The content provider platform puts the content and metadata to the Media asset manager 100. The content owner also schedules her content into a channel using a media planner service 2300. The media planner helps the content owner create a content playlist consisting of the titles the content owner has uploaded into the media asset manager 1800. The dynamic content block replacement engine takes this playlist and runs it through its subsystems to replace the dynamic block in the playlist with alternate personalised content. The output of the dynamic content block replacement engine 1900 is a channel with the new content block inserted. This channel is then passed through to the end customer when called for via the distributor app 22. This way a channel with a personalised block is passed on to the end customer.

FIG. 4a describes content blocks. Multiple content owners contribute multiple titles to the system T11 to T33 in this case. Also each content owner creates a channel playlist using an external Media planner 2500. Using the channels that it has contributed and the media planner, the content owner is able to generate a playlist with a dynamic content block inserted. The Dynamic content block is a programming block in the playlist that tells anyone parsing the playlist that content should be dynamically inserted into the block in a personalised manner. The Dynamic Content Block replacement engine 2600, reads this playlist and inserts dynamic content in this case T31, T22, in the slot where the dynamic content block exists. This generates a playlist with a block that was created dynamically based on the user profile.

FIG. 4b describes the functionality of Dynamic content block replacement. The distributor backend 3000 reaches out to the dynamic content block replacement engine for channels on behalf of their end users. The dynamic content block replacement engine passes that request to a router 1930, which decides which URL served by the ad stitching service 1920 to call. This is because the ad stitching service creates multiple streams personalized per user for the end users. The router 1930, on the basis of the user context received from the distributor backend, makes a decision on which content to pass back to the distributor backend. From the left side, the content owner creates a channel schedule on the media planner 2800. The planner outputs a playlist, which is a group of content along with the details of when they should be played. The playlist also contains the details of the dynamic block scheduled on it. The media planner marries this playlist with the content and inserts SCTE markers into the content to mark the start and finish of the dynamic block where the dynamic content should be inserted. This playlist is passed onto the content stitching service. The content stitching service 1910 looks at these SCTE markers in the content, and on the basis of the user context, inserts the content given to it by the content server 1940. The content server talks to the Media Asset Manager 2900 to fetch the relevant content from the media library. The content stitching service, in this way generates a personalized stream of content per user (or user cohort) and sends it to the ad stitching service 1920. The ad stitching service then reads the ad markers on the content stream and calls the ad server 1950 for personalized ads per user. Once these ads are stitched into the content stream, they are ready for consumption by the end user. This stitched content is then hosted onto a content delivery network (CDN), from where the router pulls the content and sends it to the distributor backend.

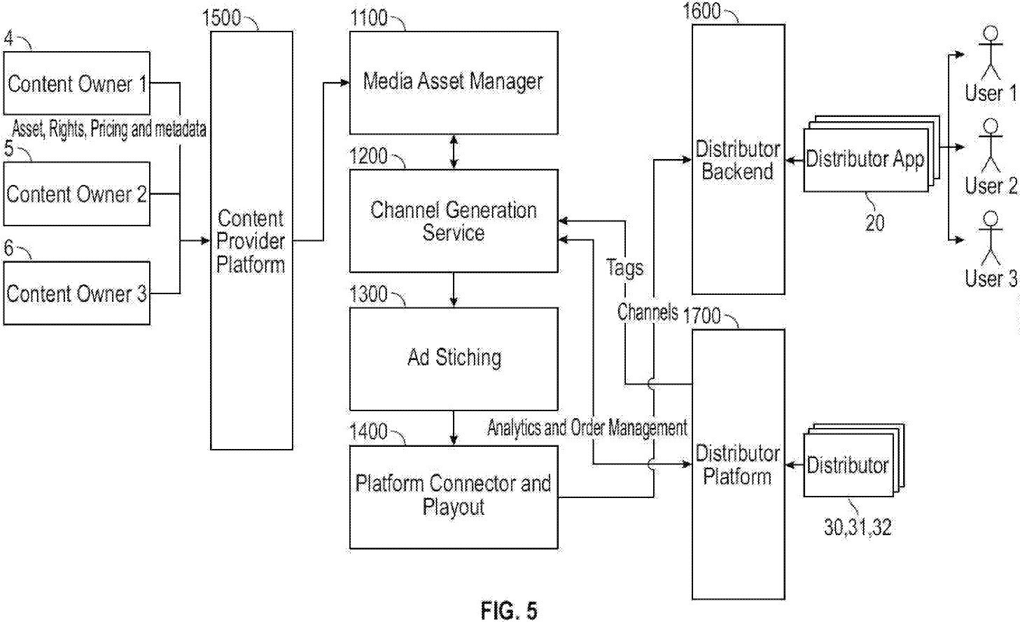

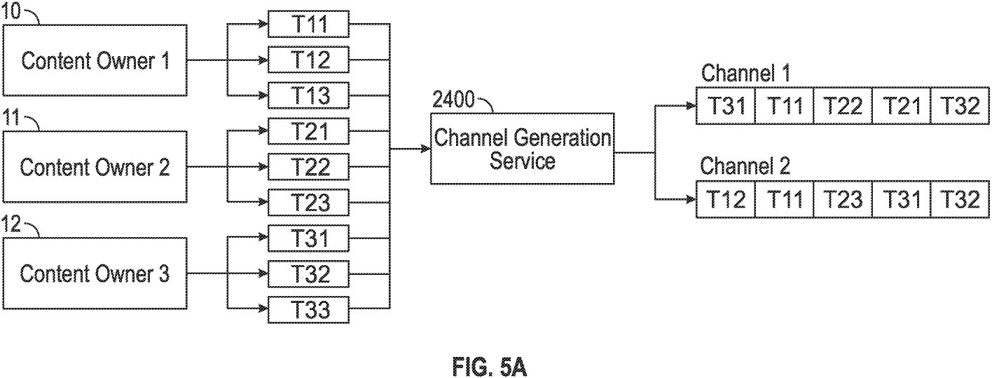

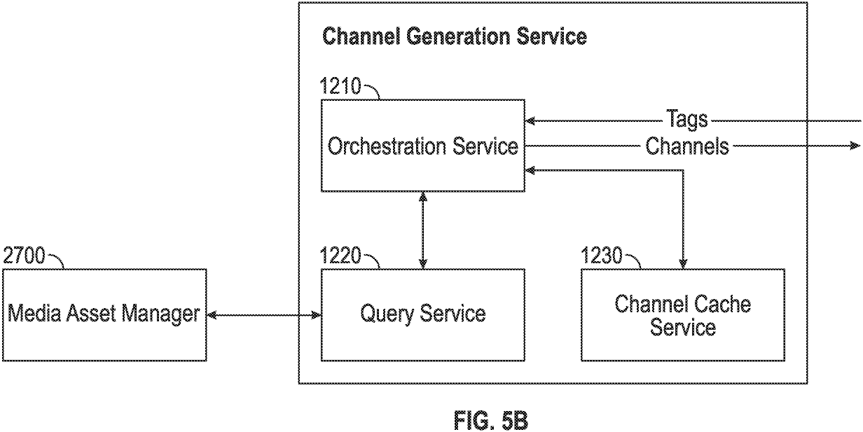

FIG. 5 illustrates Channel generation service Abstract. The channel generation service 1200 will generate channels on the fly given certain input parameters. The distributor backend reaches out to the channel generation service to generate on-the-fly channels for itself. These channels can cater to various types, for instance action, comedy, drama etc. The distributor platform 1700 passes the user context and channel tags to the channel generation service. These tags are useful when searching for content in the Media asset manager 1100. The channel generation service talks to the Media asset manager and pulls in the asset and content from it to create channels on the fly. The created channels are passed back to the distributor platform 1700. Before delivering these channels to the distributor backend 1600, the channels have to be planned into a playlist, (this is usually done through a content planning or scheduling tool), stitched with real time ads if required, through ad stitching 1300 and delivered to the platform backend using the Platform connector and playout 1400.

FIG. 5a illustrates Dynamic Channel creation. Content bouquets are on the fly channels generated for a short period of time for sale and consumption by the platforms. As you can see in thefigure, multiple content owners contribute multiple titles, from T11 to T33 to the system. The channel generation service 2400 uses these Titles to create on the fly channels, Channel 1 and Channel 2, which contain a combination of the various channels contributed by the three content owners in this example 10, 11, 12.

FIG. 5b illustrates Channel Generation Service. The Channel generation service takes input as the user context and tags, which are internally passed on the orchestration service 1210. The job of the orchestration service is to orchestrate the querying of the Media Asset Manager 2700 using the query service 1220. The query service helps formulate the query to be sent to the Media asset manager. Once the orchestration service receives a list of assets from the query service, it packs them into a single container to build a channel and passes it back to the caller (in this case the distributor platform). The orchestrator service also caches the response using the Channel cache service 1230 for faster channel retrieval in case the channel is re-requested by the distributor platform.

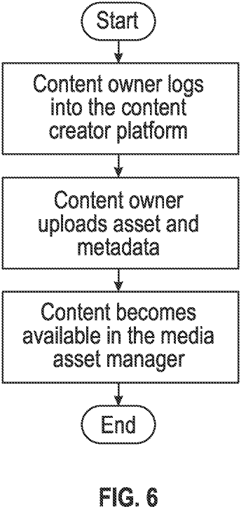

FIG. 6 illustrates Flow of insertion content and metadata into the Media Asset Manager. One or more content owners login to the content creator platform. The content owner then uploads assets and metadata and the content becomes available to the asset manager.

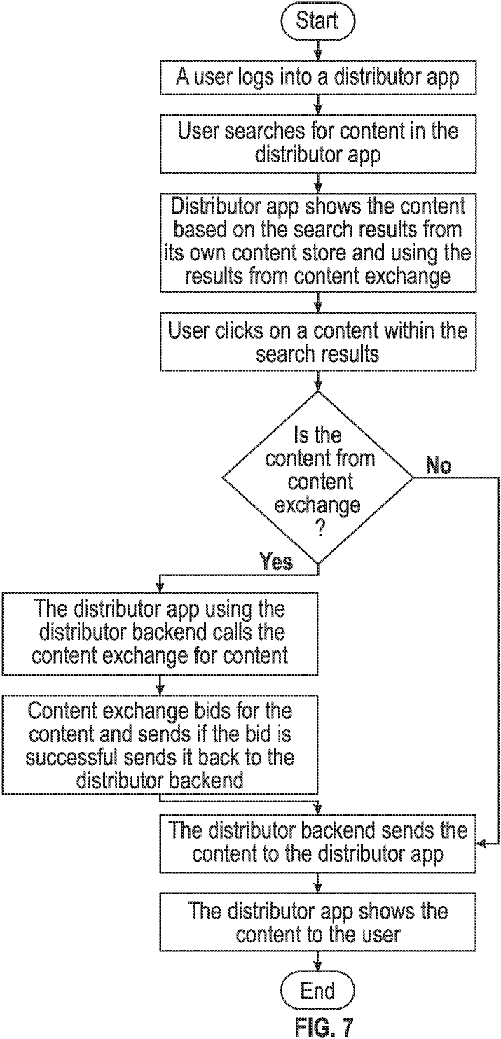

FIG. 7 illustrates Content Exchange Flow Chart. One or more users log in to a distributor app and the user searches for content. The app shows the content based on the search results from its own content store and using the results of the content exchange. A user clicks on a content within the search results. Depending on whether the content belongs to the content exchange the distributor app uses the distributor backend to call the content exchange for the content followed by the content exchange bidding for the content, sending a successful bid back to the distributor and completing the process. In case the content does not belong to the content exchange, the bidding is bypassed. This is followed by the distributor backend sending the content to the distributor app and the app supplying this to the user.

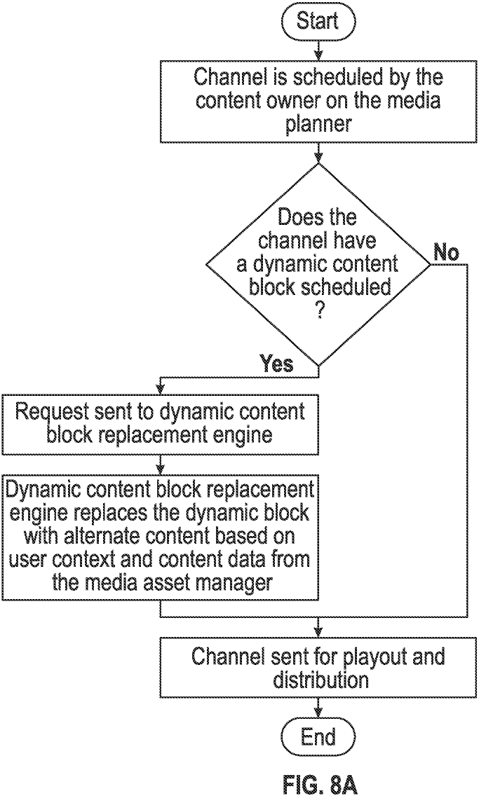

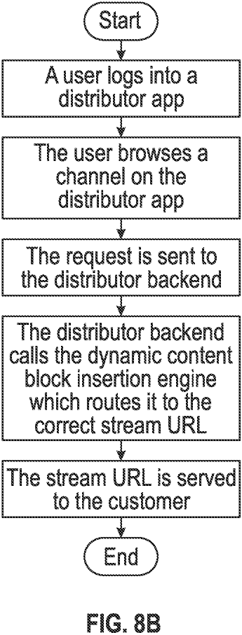

FIG. 8a illustrates Flowchart describing channel generation by the dynamic content block replacement engine where a channel is scheduled by the content owner on the media planner. A check is performed to see if the channel has a dynamic block scheduled. If so, the method sends a request to the dynamic content block replacement engine, which then replaces the dynamic block with alternate content based on user context and content data from the media asset manager. If not, the channel is sent for playout and distribution.

FIG. 8b illustrates Flowchart describing consumption of channels generated by the dynamic content block replacement engine wherein a user logs into a distributor app, browses the channel and generates a request to the distributor backend. The distributor backend calls the dynamic content block insertion engine which routes it to the content stream and serves this back to the customer.

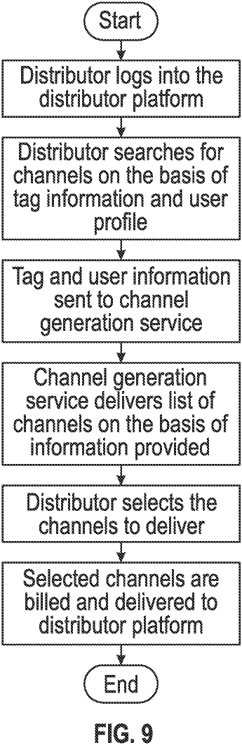

FIG. 9 illustrates Channel generation service flowchart. The distributor logs in to the distributor platform and searches for channels based on tag information and user profiles. The tag and user information are sent to the channel generation service, which delivers a list of channels based on information provided. The distributor then selects the channels to deliver, and the selected channels are billed and delivered to the distributor platform.

What is claimed is:

1) A system for programmatic exchange between content owners 1, 2, 3 and one or more distributors 30, 31, 32 that serve one or more users User1-3, comprising (a) a content provider platform 400, (b) a media asset manager 100, (c) a programmatic distribution system 200, (d) a distributor backend 500, (e) a distributor platform 600, and (f) a distributor app 20 wherein:
a) the content provider platform 400 is a conduit for one or more content owners 1,2,3 to make content they own, available for distribution;
b) the media asset manager 100 is a repository of assets, including their metadata, that are being exchanged and used for content discovery and ranking;
c) the programmatic distribution system 200;
d) the distributor backend 500 is a set of Application Programming Interfaces (APIs) hosted by the distributor, that talk to one or more distributor apps;
e) the distributor platform 600 is a platform hosted for the distributor that provides the distributor the capability to perform administrative tasks; and
f) one or more distributor applications 20 which talks to the distributor backend 500.

2) The system according to claim 1, wherein the media asset manager 100 further comprises (a) one or more media management APIs 105, (b) a transcoding service 110, (c) a meta store 115, (d) an asset store 120, (e) a data enrichment service 125, (f) a query service 130, and (g) a ranker 135 wherein:
a) one or more assets and their associated metadata are ingested through media management APIs 105 in one or more formats;
b) the transcoding service 110 encodes the video assets into an altered set of video assets that better meet the hardware and software need of the audience and is used so that the asset can be played on a wide range of devices;
c) the meta store 115 stores the metadata regarding a video file;
d) the asset store 120 stores the video assets themselves and is a large file store that can store the transcoded video assets;
e) the data enrichment service 125 takes data from the Internet to enrich asset metadata for better search capabilities;
f) the query service 130 translates the external search queries into database queries on the metadata store; and
g) the ranker does 135 helps rank the search results according to the relavence of the search results to the search query.

3) The system according to claim 1, wherein the programmatic distribution system 200 further comprises a content exchange 200-a that interacts with a delivery and distribution manager 300.

4) The system according to claim 1, wherein the programmatic distribution system 200 further comprises a dynamic content replacement engine 200-b,1900 which interacts with a media planner 2300.

5) The system according to claim 1, wherein a channel generation service 1200 creates channels on the fly, further comprising (a) ad stitching 1300, and (b) a platform connector and playout 1400.

6) The system according to claim 3, further comprising (a) an automated bidder 240, (b) a media API 210, (c) a bid manager 220, (d) a repository of bids 250, and (e) a content acquisition service 230 that interacts with a delivery and distribution manager 1000, wherein:
a) the content provider platform 800 interacts with an automated bidder 240 that talks to the content provider platform to get the floor prices and other bid details from the content provider platform;
b) the media API 210 is the API gateway to the content exchange and handles all incoming API calls to the exchange;
c) the bid manager 220 creates a bid request and starts a bid and sends it to the automated bidder 240;
d) the repository of bids 250 that stores all the bids and their statuses; and
e) the content acquisition service 230 accepts the content associated with a winning bid, said content being fetched from the media asset manager and passed onto the content acquisition service.

7) The system according to claim 6, wherein the content acquisition service solicits an advertiser to place ads on the content and subsidizes a proportion of the final charges to the viewer, based on the distributor’s request parameters.

8) The system according to claim 4, further comprising (a) one or more titles T1-T33, (b) one or more pieces of dynamic content T31, T22, (c) a content stitching service 1910, (d) a router 1930, (e) a content server 1940, and (f) an ad server 1950 wherein:
a) the media planner 2300 enables one or more content owners to schedule their content onto a channel wherein the content owner creates a content playlist consisting of the titles the content owner has uploaded into the media asset manager 1800 where the media planner 2300 then places SCTE markers as a placeholder to indicate the start and finish of one or more dynamic blocks;
b) the dynamic content block replacement engine 1900 takes this playlist and runs it through its subsystems to replace the dynamic block in the playlist with alternate dynamic content T31, T22 that is then delivered to one or more end-users 1,2,3;
c) the content stitching service (1910) looks at these SCTE markers in the content, and on the basis of the user context, inserts the content given to it by the content server (1940), thereby generating dynamic content; and
d) the content server 1940 talks to the Media Asset Manager 2900 to fetch the relevant content from the media library.

9) The system according to claim 5, further comprising (a) an orchestration service 1210, (b) a query service 1220, and (c) a channel cache service 1230 wherein:
a) the orchestration service 1210 takes in tags from the channel generation service and orchestrates the querying of the Media Asset Manager 2700 using the query service 1220 such that when the orchestration service receives a list of assets from the query service, it packs them into a single container to build a channel and passes it back to the distributor platform;
b) the query service 1220 helps formulate the query to be sent to the Media asset manager; and
c) the channel cache service 1230 caches the response from the query service or faster channel retrieval in case the channel is re-requested by the distributor platform.

10) A method for programmatic distribution between content owners 1, 2, 3 and one or more distributors 30, 31, 32 that serve one or more users User1-3, comprising the steps of:
a) populating the media asset manager with content and metadata;
b) performing programmatic distribution; and
c) delivering content back to the users for consumption.

11) The method according to claim 10, wherein the step of populating the media asset manager with content and metadata further comprises the steps of:
a) logging in one or more content owners to the content creator platform; and
b) uploading metadata and the content becomes available to the asset manager by the content owner.

12) The method according to claim 10, wherein programmatic distribution is performed via content exchange further comprising the steps of:
a) logging in one or more users log in to a distributor app;
b) searching for content that the user wants;
c) showing the relevant content to the user based on the search results from its own content store and using the results of the content exchange;
d) a user clicking on a content within the search results;
e) checking to see whether the content belongs to the content exchange and
i) if so, the distributor app uses the distributor backend to call the content exchange for the content followed by the content exchange bidding for the content, sending a successful bid back to the distributor and completing the process; and
ii) if not, the bidding is bypassed; and
f) this is followed by the distributor backend sending the content to the distributor app and the app supplying this to the user.

13) The method according to claim 10, wherein programmatic distribution is performed via dynamic content block replacement to personalize content for end-users.

14) The method according to claim 13, wherein programmatic distribution is performed via dynamic content block replacement to place ads personalized to end-users.

15) The method according to claim 13, wherein a media asset manager utilizes SCTE markers to act as placeholders to indicate the start and finish of dynamic content to be inserted.

16) The method according to claim 13, wherein a media asset manager utilizes SCTE markers to act as placeholders to indicate the start and finish of advertising content to be inserted.

17) The method according to claim 10, wherein a channel generation module further comprises the steps of:
a) one or more distributors logging in to a distributor platform;
b) distributors searching for channels based on tag information and user profiles;
c) sending the tag and user information to the channel generation service, which delivers a list of channels based on information provided;
d) the distributor selecting the channels to deliver;
e) billing the selected channels; and
f) delivering the channels to the distributor.

18) The system according to claim 4, further comprising (a) one or more tiles T1-T33, (b) one or more pieces of dynamic content T31, T22, (c) a content stitching service 1910, (d) an ad stitching service 1920, (e) a router 1930, (f) a content server 1940, and (g) an ad server 1950 wherein:
a) the media planner 2300 enables one or more content owners to schedule their content onto a channel wherein the content owner creates a content playlist consisting of the titles the content owner has uploaded into the media asset manager (1800) where the media planner 2300 then places SCTE markers as a placeholder to indicate the start and finish of one or more dynamic blocks;
b) the dynamic content block replacement engine 1900 takes this playlist and runs it through its subsystems to replace the dynamic block in the playlist with alternate dynamic content T31, T22 that is then delivered to one or more end-users 1,2,3;
c) the content stitching service (1910) looks at these SCTE markers in the content, and on the basis of the user context, inserts the content given to it by the content server (1940), thereby generating personalized content/dynamic content;
d) the content server 1940 talks to the Media Asset Manager 2900 to fetch the relevant content from the media library; and
e) the ad stitching service takes the content sent to it by the content stitching service, reads the ad markers on the content stream and calls the ad server (1950) for personalised ads per user.
